(19) United States
(12) Patent Application Publication
(10) Pub. No.: US 2026/0205804 A1
(43) Pub. Date: Jul. 16, 2026

(54) PRE-SHARED SECRET KEY GENERATION FOR INTEGRATED ACCESS AND BACKHAUL NETWORK DEVICE

(71) Applicant: ZTE CORPORATION, Shenzhen, Guangdong (CN)

(72) Inventors: Yuze LIU, Shenzhen (CN); Shilin YOU, Shenzhen (CN); Peilin LIU, Shenzhen (CN); Wei MA, Shenzhen (CN)

(21) Appl. No.: 19/135,534

(22) PCT Filed: Apr. 7, 2023
(86) PCT No.: PCT/CN2023/087125

§ 371 Date: Jun. 4, 2025

(51) Int. Cl. H04W 12/0431; H04W 36/00; H04W 76/20; H04W 88/08; H04W 92/24

(52) U.S. Cl. CPC H04W 12/0431; H04W 36/0016; H04W 76/20; H04W 88/08; H04W 92/24

(57) ABSTRACT

Systems, methods, and apparatus for wireless communication are described. A wireless communication method includes receiving, by an integrated access and backhaul (IAB) node, a new internet protocol (IP) address. The method further includes sending, by the IAB node, an indication to update a pre-shared secret key (PSK) based on the new IP address. The method further includes generating, by the IAB node, an updated PSK. The described techniques may be adopted by a network device or by a wireless device.

### CROSS REFERENCE

This disclosure is a national stage filing under 35 U.S.C. § 371 of international application number PCT/CN2023/087125, filed Apr. 7, 2023, the entire contents of which are incorporated herein by reference.

### TECHNICAL FIELD

This patent document is directed generally to wireless communications.

### BACKGROUND

Mobile telecommunication technologies are moving the world toward an increasingly connected and networked society. In comparison with the existing wireless networks, next-generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data rates, large number of connections, ultra-low latency, high reliability, and other emerging business needs.

### SUMMARY

Techniques are disclosed for sending indications to update pre-shared secret keys (PSKs) and generating updated PSKs.

A first example wireless communication method includes receiving, by an integrated access and backhaul (IAB) node, a new internet protocol (IP) address. The method further includes sending, by the IAB node, an indication to update a pre-shared secret key (PSK) based on the new IP address. The method further includes generating, by the IAB node, an updated PSK.

A second example wireless communication method includes receiving, by an integrated access and backhaul (IAB) node, a new internet protocol (IP) address. The method further includes receiving, by the IAB node, an indication to update a pre-shared secret key (PSK) based on the new IP address. The method further includes generating, by the IAB node, an updated PSK.

A third example wireless communication method includes receiving, by an integrated access and backhaul (IAB) node, a new IAB distributed unit (IAB-DU) internet protocol (IP) address. The method further includes receiving, by the IAB node, a pre-shared secret key (PSK) generated based on the new IAB-DU IP address and using one of the following keys: a gNodeB (gNB) key, a secondary gNB key, a secondary node (SN) key, or an IAB key.

A fourth example wireless communication method includes receiving, by an integrated access and backhaul (IAB) node, a new IAB distributed unit (IAB-DU) internet protocol (IP) address. The method further includes generating, by the IAB node, a pre-shared secret key (PSK) based on the new IAB-DU IP address and using one of the following keys: a gNodeB (gNB) key, a secondary gNB key, a secondary node (SN) key, or an IAB key.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWINGS

FIG. 1 illustrates an exemplary handover procedure.

FIG. 2 illustrates an exemplary topology adaptation procedure.

FIG. 3 illustrates an exemplary radio link failure (RLF) recovery procedure.

FIG. 4 is an exemplary flowchart for sending an indication to update a pre-shared secret key (PSK).

FIG. 5 is an exemplary flowchart for receiving an indication to update a pre-shared secret key (PSK).

FIG. 6 is an exemplary flowchart for receiving a pre-shared secret key (PSK).

FIG. 7 is an exemplary flowchart for generating a pre-shared secret key (PSK).

FIG. 8 illustrates an exemplary block diagram of a hardware platform that may be a part of a network device or a communication device.

FIG. 9 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only and may be used in wireless systems that implemented other protocols.

### I. Introduction

When the Integrated Access and Backhaul (IAB) mobile termination (IAB-MT) is migrated from a source IAB-donor central unit (CU) to a target IAB-donor-CU, the migrating IAB-node becomes a boundary IAB-node since its IAB distributed unit (IAB-DU) retains F1 Application Protocol (F1AP) with the source IAB-donor-CU while its IAB-MT obtains Radio Resource Control (RRC) connectivity with the target IAB-donor-CU detailed in TS 38.401.

If new Transport Network Layer (TNL) addresses for F1 control (F1-C) traffic are configured, new Stream Control Transmission Protocol (SCTP) association(s) between the migrating IAB-node and the F1-terminating IAB-donor-CU may be established using the new TNL address information of the migrating IAB-node. The migrating IAB-node sends an F1AP gNodeB gNB-DU CONFIGURATION UPDATE message to the F1-terminating IAB-donor-CU, which may include new (outer) Internet Protocol (IP) addresses and corresponding new (inner) IP address for the F1 user (F1-U) traffic to be switched to the target path.

In this case, it is useful to specify the security procedure to re-establish the F1 security.

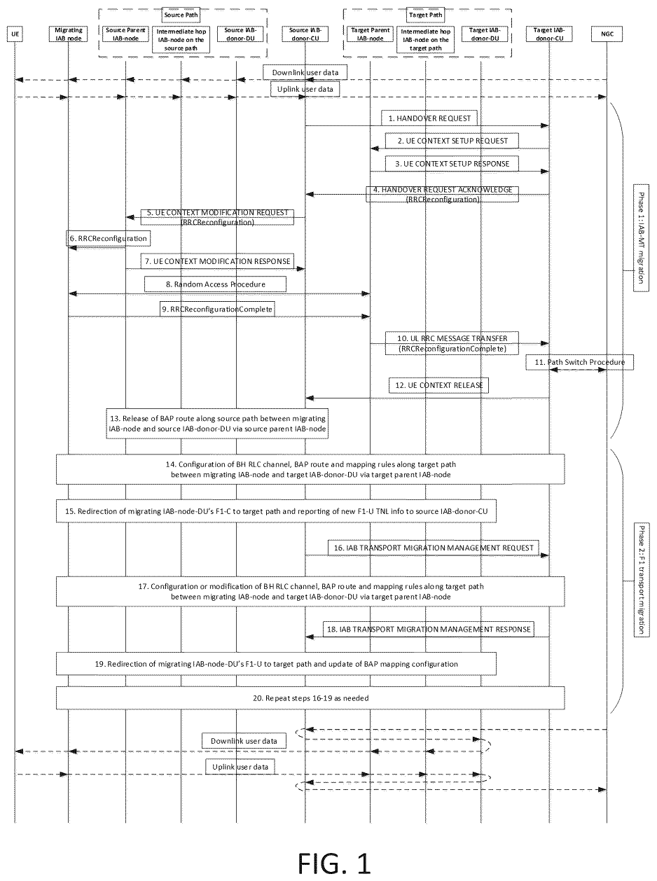

As specified in 3GPP TS 38.401 clause 8.17.3 and shown in FIG. 1, a handover procedure may take 20 steps. The terms in FIG. 1 are explained as follows.

UE: User Equipment.

Migrating IAB node: An IAB node whose IAB-MT is migrated from a source IAB-donor-CU to a target IAB-donor-CU.

Source path: The path between a source parent IAB-node and a source IAB-donor-DU.

Source parent IAB-node: An IAB-MT's source next hop neighbor node.

Intermediate hop IAB-node on the source path: The IAB node between a source parent IAB-node and a source IAB-donor-DU on the source path.

Source IAB-donor-DU: The gNB-DU of a source IAB-donor, hosting the IAB BAP sublayer and providing wireless backhaul to IAB-nodes.

Source IAB-donor-CU: The gNB-CU of a source IAB-donor, terminating the F1 interface towards IAB-nodes and an IAB-donor-DU.

Target path: The path between a target parent IAB-node and a target IAB-donor-DU.

Target parent IAB-node: An IAB-MT's target next hop neighbor node.

Intermediate hop IAB-node on the target path: The IAB node between a target parent IAB-node and a target IAB-donor-DU on the target path.

Target IAB-donor-DU: The gNB-DU of a target IAB-donor, hosting the IAB BAP sublayer and providing wireless backhaul to IAB-nodes.

Target IAB-donor CU: The gNB-CU of a target IAB-donor, terminating the F1 interface towards IAB-nodes and an IAB-donor-DU.

NGC: Next Generation Core Network.

Downlink user data: In general, user data that is transmitted in the direction from network to UE.

Uplink user data: An “uplink” is a unidirectional radio link for the transmission of signals from a UE to a base station, from a mobile station to a mobile base station, or from a mobile base station to a base station. In general, user data that is transmitted in the direction from UE to network.

IAB-MT migration: An IAB-MT is migrated from a source IAB-donor-CU to a target IAB-donor-CU.

F1 transport migration: The F1 connection between the migrating IAB-node and the source IAB-donor-CU is switched to the target path using the new TNL address information of the migrating IAB-node.

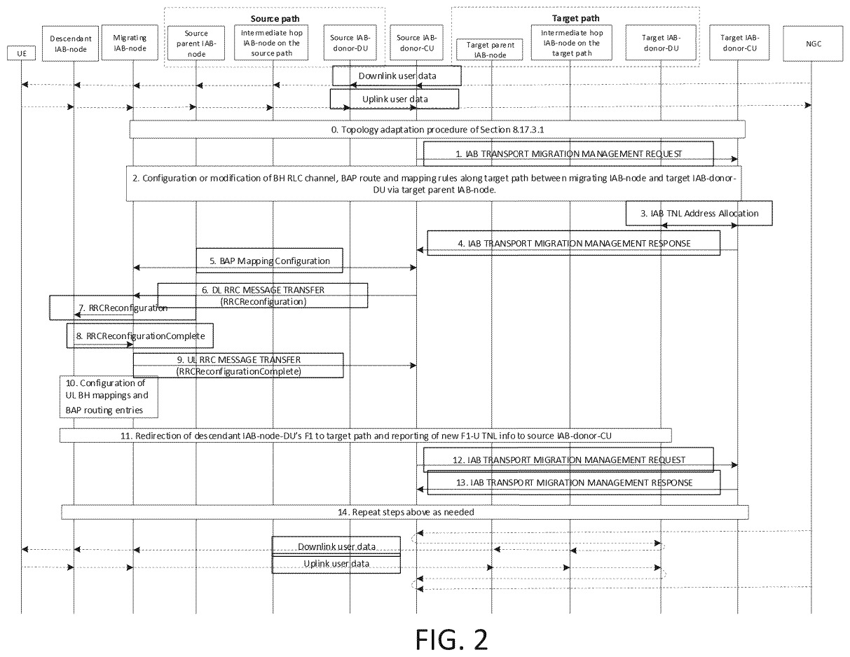

As shown in FIG. 2, a topology adaptation procedure may take 15 steps. Except the terms that are already introduced in FIG. 1, the terms in FIG. 2 are explained as follows.

Descendant IAB-node: An IAB node whose parent IAB node is the migrating IAB-node.

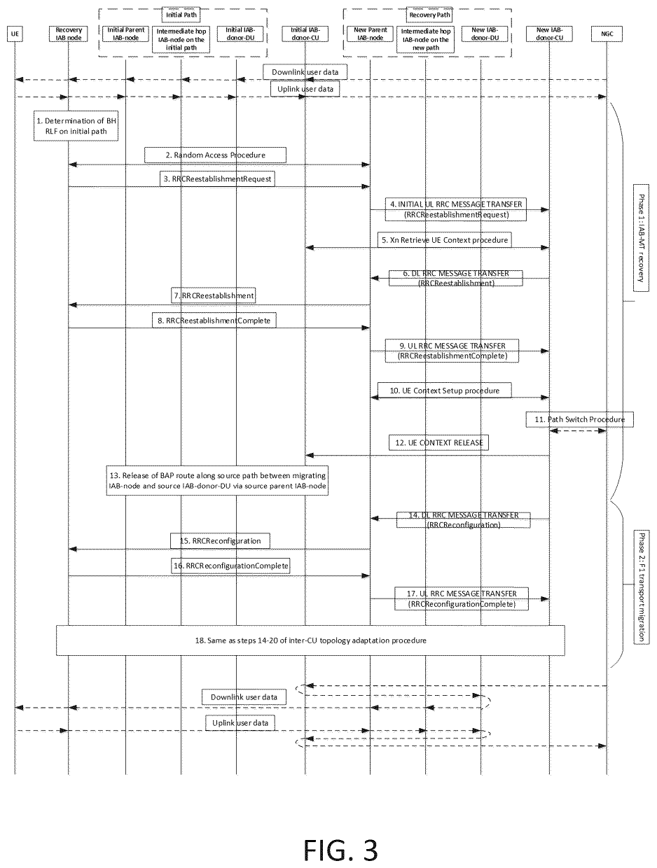

As shown in FIG. 3, a radio link failure (RLF) recovery procedure may take 18 steps. Except the terms that are already introduced in FIG. 1 and FIG. 2, the terms in FIG. 3 are explained as follows.

Recovery IAB-node: An IAB node whose IAB-MT is migrated from an initial IAB-donor-CU to a new IAB-donor-CU.

Initial path: The path between an initial parent IAB-node and an initial IAB-donor-DU.

Initial parent IAB-node: An IAB-MT's initial next hop neighbor node.

Intermediate hop IAB-node on the initial path: The IAB node between an initial parent IAB-node and an initial IAB-donor-DU on the initial path.

Initial IAB-donor-DU: The gNB-DU of an initial IAB-donor, hosting the IAB BAP sublayer and providing wireless backhaul to IAB-nodes.

Initial IAB-donor-CU: The gNB-CU of an initial IAB-donor, terminating the F1 interface towards IAB-nodes and an IAB-donor-DU.

Recovery path: The path between a new parent IAB-node and a new IAB-donor-DU.

New parent IAB-node: The gNB-DU of a new IAB-donor, hosting the IAB BAP sublayer and providing wireless backhaul to IAB-nodes.

Intermediate hop IAB-node on the new path: The IAB node between a new parent IAB-node and a new IAB-donor-DU on the new path.

New IAB-donor-DU: The gNB-DU of a new IAB-donor, hosting the IAB BAP sublayer and providing wireless backhaul to IAB-nodes.

New IAB-donor-CU: The gNB-CU of a new IAB-donor, terminating the F1 interface towards IAB-nodes and an IAB-donor-DU.

Based on the existing handover procedure as shown in FIG. 1, the topology adaptation procedure as shown in FIG. 2, and the RLF recovery procedure as shown in FIG. 3, this patent document modifies the existing procedures to send indications to update pre-shared secret keys (PSKs) and generating updated PSKs. The modified handover procedure is described in Embodiment 1. The modified topology adaptation procedure is described in Embodiment 2. The modified RLF recovery procedure is described in Embodiment 3.

### II. Embodiment 1: Handover Procedure

As shown in FIG. 1, a handover procedure may take 20 steps. Steps 4, 6, and 15 are modified to send indications to update pre-shared secret keys (PSKs) and generating updated PSKs.

1. The source IAB-donor-CU sends an Xn HANDOVER REQUEST message to the target IAB-donor-CU. This message may include the migrating IAB-node's TNL address information in the RRC container.

2. The target IAB-donor-CU sends a user equipment UE CONTEXT SETUP REQUEST message to the target parent node IAB-DU, to create the UE context for the migrating IAB-MT and to set up the bearers, which the migrating IAB-MT uses for its signaling, and, optionally, data traffic.

3. The target parent node IAB-DU responds to the target IAB-donor-CU with a UE CONTEXT SETUP RESPONSE message.

4. The target IAB-donor-CU performs admission control and provides the new RRC configuration as part of the HANDOVER REQUEST ACKNOWLEDGE message. The RRC configuration includes a Backhaul Adaptation Protocol (BAP) address for the boundary node in the target IAB-donor-CU's topology, a default backhaul (BH) radio link control (RLC) channel and a default BAP routing identification (ID) configuration for uplink (UL) F1-C/non-F1 traffic mapping on the target path. The RRC configuration may include the new TNL address(es) anchored at the target IAB-donor-DU for the migrating node. The target IAB-node may also send an indication in a message, such as the HANDOVER REQUEST ACKNOWLEDGE message, to indicate that the PSK between the descendant IAB-node and F1-terminating IAB-donor-CU should be changed.

5. The source IAB-donor-CU sends a UE CONTEXT MODIFICATION REQUEST message to the source parent node IAB-DU, which includes the received RRCReconfiguration message from the target IAB-donor-CU.

6. The source parent node IAB-DU forwards the received RRCReconfiguration message to the migrating IAB-MT. The source IAB-node should also send an indication in a message, such as the RRCReconfiguration message, to indicate that the PSK between the descendant IAB-node and F1-terminating IAB-donor-CU should be changed. The source IAB-node holds the mapping between the old TNL address (IP address), old IAB key (KIAB), and new TNL address (IP address).

7. The source parent node IAB-DU responds to the source IAB-donor-CU with the UE CONTEXT MODIFICATION RESPONSE message.

8. The migrating IAB-MT performs a random access procedure at the target parent node IAB-DU.

9. The migrating IAB-MT responds to the target parent node IAB-DU with an RRCReconfigurationComplete message.

10. The target parent node IAB-DU sends an UL RRC MESSAGE TRANSFER message to the target IAB-donor-CU, to convey the received RRCReconfigurationComplete message.

11. The target IAB-donor-CU triggers the path switch procedure for the migrating IAB-MT, if needed.

12. The target IAB-donor-CU sends UE CONTEXT RELEASE message to the source IAB-donor-CU.

The Xn Application Protocol (XnAP) UE IDs of the migrating node are retained at target and source IAB-donor-CU as long as the target path is used for transport of traffic between the migrating node and the source IAB-donor-CU.

13. The source IAB-donor-CU may release BH RLC channels and BAP-sublayer routing entries on the source path between source parent IAB-node of the migrating IAB-node and the source IAB-donor-DU.

14. The target IAB-donor-CU configures BH RLC channels and BAP-sublayer routing entries on the target path between the migrating IAB-node and target IAB-donor-DU, as well as downlink (DL) mappings on the target IAB-donor-DU for the migrating IAB-node's target path. These configurations support the transport of F1-C traffic on the target path.

15. The F1-C connection between the migrating IAB-node and the source IAB-donor-CU are switched to the target path using the new TNL address information of the migrating IAB-node. The migrating IAB-node may report the new TNL address information it wants to use for F1-U traffic to the source IAB-donor-CU, via the gNB-DU CONFIGURATION UPDATE message.

In case Internet Protocol Security (IPsec) tunnel mode is used for TNL protection, the migrating IAB-node may use IKEv2 Mobility and Multihoming Protocol (IETF RFC 4555: MOBIKE) to migrate the IPsec tunnel to the new IP outer addresses. After the completion of the MOBIKE procedure, the migrating IAB-DU initiates an F1AP gNB-DU Configuration Update procedure from which the IAB-donor-CU can conclude whether the existing inner IP address(es) (e.g., for SCTP association) and the DL F-tunnel endpoint identifiers (F-TEID) can be reused.

If new TNL addresses for F1-C traffic are configured, new SCTP association(s) between the migrating IAB-node and the F1-terminating IAB-donor-CU may be established using the new TNL address information of the migrating IAB-node. The migrating IAB-node sends an F1AP gNB-DU CONFIGURATION UPDATE message to the F1-terminating IAB-donor-CU, which may include new (outer) IP addresses and corresponding new (inner) IP address for the F1-U traffic to be switched to the target path.

The migrating IAB-node should also send an indication in a message, such as the gNB-DU configuration update message, to indicate that the PSK between the migrating IAB-node and F1-terminating IAB-donor-CU should be changed.

Based on the indication, the IAB-node and the F1-terminating IAB-donor-CU generate a new PSK or KIAB as follows.

### KIAB Generation Method 1:

### KIAB Generation Function

This input string is used when the IAB-node and the IAB-donor derive KIAB (PSK) for establishment of a secure F1 interface. The following parameters shall be used to form the input S to the Key Distribution Function (KDF):

$$FC = 0 \times 83 ,$$

P0=IAB-donor-CU IP address,
L0=length of IAB-donor-CU IP address,
P1=IAB-node DU IP address,
L1=length of IAB-node DU IP address.

The input key KEY can be KgNB, if the key KgNB is in possession of the IAB-UE functionality in the IAB-node and in the IAB-donor-CU (also when acts as master node (MN) for New Radio (NR) Dual Connectivity (NR-DC) scenario), after the IAB-UE setup procedure.

The input key KEY can be S-KgNB, if the key S-KgNB is in possession of the IAB-UE functionality in the IAB-node and in the IAB-donor-CU (acts as a secondary node (SN) for E-UTRA-NR DC (EN-DC) scenario), after dual connectivity procedure.

The input key KEY can be KSN, if the key KSN is in possession of the IAB-UE functionality in the IAB-node and in the IAB-donor-CU (acts as a SN for NR-DC scenario), after dual connectivity procedure.

For P0, in case of control plane (CP)-UP separation of IAB-donor-CU,

P0 shall be set to IAB-donor-CU-CP IP address for deriving KIAB-CU-CP;

P0 shall be set to IAB-donor-CU-UP IP address for deriving KIAB-CU-UP.

The entire output of the KDF (256 bits) is used as the KIAB or KIAB-CU-CP or KIAB-CU-UP.

The P1 should be the new IAB-node DU IP address.

The L1 should be the length of the new IAB-node DU IP address.

### KIAB Generation Method 2:

Source IAB-donor can use the IAB-node DU IP address (either old or new IAB-node DU IP address) to find the old PSK (KIAB).

### KIAB Generation Function

This input string is used when the IAB-node and the IAB-donor derive KIAB (PSK) for establishment of secure F1 interface. The following parameters may be used to form the input S to the KDF:

$$FC = 0 \times 83 ,$$

P0=IAB-donor-CU IP address,
L0=length of IAB-donor-CU IP address,
P1=IAB-node DU IP address,
L1=length of IAB-node DU IP address.

The input key KEY can be KgNB, if the key KgNB is in possession of the IAB-UE functionality in the IAB-node and in the IAB-donor-CU (also when acts as MN for NR-DC scenario), after the IAB-UE setup procedure.

The input key KEY can be S-KgNB, if the key S-KgNB is in possession of the IAB-UE functionality in the IAB-node and in the IAB-donor-CU (acts as a SN for EN-DC scenario), after dual connectivity procedure.

The input key KEY can be KSN, if the key KSN is in possession of the IAB-UE functionality in the IAB-node and in the IAB-donor-CU (acts as a SN for NR-DC scenario), after dual connectivity procedure.

For P0, in case of CP-UP separation of IAB-donor-CU,

P0 shall be set to IAB-donor-CU-CP IP address for deriving KIAB-CU-CP;

P0 shall be set to IAB-donor-CU-UP IP address for deriving KIAB-CU-UP.

The entire output of the KDF (256 bits) is used as the KIAB or KIAB-CU-CP or KIAB-CU-UP.

The input key KEY shall be KIAB.

The P1 should be the new IAB-node DU IP address.

The L1 should be the length of the new IAB-node DU IP address.

16. The source IAB-donor-CU sends an IAB TRANSPORT MIGRATION MANAGEMENT REQUEST message to the target IAB-donor-CU, to provide the context of the traffic to be offloaded. The message may include the new DL TNL address information necessary for the target IAB-donor-CU to configure or modify DL mappings on the target IAB-donor-DU.

17. The target IAB-donor-CU may configure or modify BH RLC channels and BAP-sublayer routing entries on the target path between the migrating IAB-node and target IAB-donor-DU, as well as DL mappings on the target IAB-donor-DU for the migrating IAB-node's target path. These configurations may support the transport of user plane (UP) and non-UP traffic on the target path.

18. The target IAB-donor-CU responds to the source IAB-donor-CU with an IAB TRANSPORT MIGRATION MANAGEMENT RESPONSE message, to provide the mapping information for the traffic to be offloaded. The message includes the layer-2 (L2) info that is used in the target IAB-donor-CU's topology and necessary to configure the migrating IAB-node with the UL mappings of traffic indicated in step 16. The message includes the differentiated services code point (DSCP)/IP Version 6 (IPv6) Flow Label values used to configure the DL mappings of traffic indicated in step 16.

19. The F1-U connections of the migrating IAB-node with the source IAB-donor-CU are switched to use the migrating IAB-node's new TNL address(es). The source IAB-donor-CU provides to the IAB-DU of the migrating IAB-node the updated UL BH information for the traffic indicated in step 16, based on the UL BH information received from the target IAB-donor-CU in step 18. The source IAB-donor-CU may also update the UL BH information associated with non-UP traffic. This step may use UE associated signaling or non-UE associated signaling in E1 and/or F1 interface. Implementation must ensure the avoidance of potential race conditions, i.e., that no conflicting configurations are concurrently performed using UE-associated and non-UE-associated procedures.

20. The steps 16 to 19 may be repeated, if needed, where the source IAB-donor-CU can request the offload of further traffic, or the modification or release of offloaded traffic. The target IAB-donor-CU can fully or partially reject addition or modification requests by the source IAB-donor-CU.

### III. Embodiment 2: Topology Adaptation Procedure

FIG. 2 shows an example of the topology adaptation procedure where the migrating IAB-MT is migrated from a source IAB-donor-CU to a target IAB-donor-CU, and where the migrating IAB-node has a descendant IAB-node which retains both its RRC connection and F1 connection with the source IAB-donor-CU. A topology adaptation procedure may take 15 steps. Steps 4, 6, and 11 are modified to send indications to update pre-shared secret keys (PSKs) and generating updated PSKs.

0. The topology adaptation procedure of clause 8.17.3.1 is performed for the migrating IAB-node.

1. The source IAB-donor-CU sends an IAB TRANSPORT MIGRATION MANAGEMENT REQUEST message to the target IAB-donor-CU to provide the context of the descendant IAB-node's traffic to be offloaded. The message may include a request for new TNL address(es) for the descendant IAB-node(s), anchored at a target IAB-donor-DU. The source IAB-donor-CU includes an identifier of the migrating IAB-node in the request message. This could be performed in parallel with step 0 after the source IAB-donor-CU receives HANDOVER REQUEST ACKNOWLEDGE message, e.g., the context of the traffic to be offloaded for the migrating/descendant nodes and IP address request information could be contained in the same IAB TRANSPORT MIGRATION MANAGEMENT REQUEST message.

2. The target IAB-donor-CU determines the target IAB-donor-DU, based on the identifier of the migrating IAB-node. The target IAB-donor-CU may configure or modify BH RLC channels and BAP-sublayer routing entries on the target path between the boundary IAB-node and target IAB-donor-DU, as well as DL mappings on the target IAB-donor-DU for the migrating IAB-node's target path. These configurations may support the transport of UP and non-UP traffic on the target path.

3. The target IAB-donor-CU may obtain new TNL address(es) from the target IAB-donor-DU, based on the request for TNL address(es) received in step 1.

4. The target IAB-donor-CU responds with an IAB TRANSPORT MIGRATION MANAGEMENT RESPONSE message to the source IAB-donor-CU, to provide the mapping information for the traffic to be offloaded. The message includes the L2 info from the target IAB-donor-CU topology that is necessary to configure the migrating IAB-node with the BAP-sublayer routing, header-rewriting and BH RLC CH mapping entries of traffic indicated in step 1. The message includes the DSCP/IPV6 Flow Label values to be used for the DL traffic to be offloaded as indicated in step 1. The message may include the new TNL address(es) obtained in step 3, if any. The target IAB-node may also send an indication in a message, such as the IAB TRANSPORT MIGRATION MANAGEMENT RESPONSE message, to indicate that the PSK between the descendant IAB-node and F1-terminating IAB-donor-CU should be changed.

The target IAB-donor-CU should select the same IAB-donor-DU in its IAB topology for all to-be-offloaded traffic, whose UL BH mappings received from the source IAB-donor-CU in step 1 share the same BAP address.

5. The source IAB-donor-CU configures the migrating IAB-node's IAB-DU with the BAP-sublayer routing, header-rewriting and BH RLC CH mapping entries of the migrating IAB-node.

6. The source IAB-donor-CU sends a DL RRC MESSAGE TRANSFER message to the descendant IAB-node's parent IAB-DU, which includes an RRCReconfiguration message for the descendant IAB-MT. The RRC configuration may include the new TNL addresses received in step 4. If needed, the source IAB-donor-CU may also provide a new default UL mapping which includes a default BH RLC channel and a default BAP Routing ID on the target path, to the descendant nodes via RRCReconfiguration message. The source IAB-node should also send an indication in a message, such as the RRCReconfiguration message, to indicate that the PSK between the descendant IAB-node and F1-terminating IAB-donor-CU should be changed. The source IAB-node holds the mapping between the old TNL address (IP address), old KIAB, and new TNL address (IP address).

7. The descendant IAB-node's parent IAB-DU forwards the received RRCReconfiguration message to the descendant IAB-MT.

8. The descendant IAB-MT responds to the migrating IAB-node's IAB-DU with an RRCReconfigurationComplete message.

9. The migrating IAB-node's IAB-DU sends an UL RRC MESSAGE TRANSFER message to the source IAB-donor-CU, to convey the received RRCReconfigurationComplete message.

10. If needed, the source IAB-donor-CU configures UL BH mappings on the descendant node and BAP-sublayer routing entries between the descendant node and the migrating IAB-node. This step may be performed at an earlier stage, e.g., immediately after step 4.

11. The F1-C connections and F1-U tunnels are switched to use the descendant IAB-node's new TNL address(es), if any, as described in Steps 15 and 19 of the inter-CU topology adaptation procedure in clause 8.17.3.1.

If the descendant IAB-node does not receive the indication from source IAB-node, the descendant IAB-node should also send an indication in a message, such as the gNB-DU configuration update message, to indicate that the PSK between the descendant IAB-node and F1-terminating IAB-donor-CU should be changed.

Based on the indication, the IAB-node and the F1-terminating IAB-donor-CU generate a new PSK or KIAB as follows.

### KIAB Generation Method 1:

### KIAB Generation Function

This input string is used when the IAB-node and the IAB-donor derive KIAB

(PSK) for establishment of secure F1 interface. The following parameters shall be used to form the input S to the KDF:

$$FC = 0 \times 83 ,$$

P0=IAB-donor-CU IP address,
L0=length of IAB-donor-CU IP address,
P1=IAB-node DU IP address,
L1=length of IAB-node DU IP address.

The input key KEY can be KgNB, if the key KgNB is in possession of the IAB-UE functionality in the IAB-node and in the IAB-donor-CU (also when acts as MN for NR-DC scenario), after the IAB-UE setup procedure.

The input key KEY can be S-KgNB, if the key S-KgNB is in possession of the IAB-UE functionality in the IAB-node and in the IAB-donor-CU (acts as a SN for EN-DC scenario), after dual connectivity procedure.

The input key KEY can be KSN, if the key KSN is in possession of the IAB-UE functionality in the IAB-node and in the IAB-donor-CU (acts as a SN for NR-DC scenario), after dual connectivity procedure.

For P0, in case of CP-UP separation of IAB-donor-CU,

P0 shall be set to IAB-donor-CU-CP IP address for deriving KIAB-CU-CP;

P0 shall be set to IAB-donor-CU-UP IP address for deriving KIAB-CU-UP.

The entire output of the KDF (256 bits) is used as the KIAB or KIAB-CU-CP or KIAB-CU-UP.

The P1 should be the new IAB-node DU IP address.

The L1 should be the length of the new IAB-node DU IP address.

### KIAB Generation Method 2:

Source IAB-donor can use the IAB-node DU IP address (either old or new IAB-node DU IP address) to find the old PSK (KIAB).

### KIAB Generation Function

This input string is used when the IAB-node and the IAB-donor derive KIAB (PSK) for establishment of secure F1 interface. The following parameters shall be used to form the input S to the KDF:

$$FC = 0 \times 83 ,$$

P0=IAB-donor-CU IP address,
L0=length of IAB-donor-CU IP address,
P1=IAB-node DU IP address,
L1=length of IAB-node DU IP address.

The input key KEY can be KgNB, if the key KgNB is in possession of the IAB-UE functionality in the IAB-node and in the IAB-donor-CU (also when acts as MN for NR-DC scenario), after the IAB-UE setup procedure.

The input key KEY can be S-KgNB, if the key S-KgNB is in possession of the IAB-UE functionality in the IAB-node and in the IAB-donor-CU (acts as a SN for EN-DC scenario), after dual connectivity procedure.

The input key KEY shall be KSN, if the key KSN is in possession of the IAB-UE functionality in the IAB-node and in the IAB-donor-CU (acts as a SN for NR-DC scenario), after dual connectivity procedure.

For P0, in case of CP-UP separation of IAB-donor-CU,

P0 shall be set to IAB-donor-CU-CP IP address for deriving KIAB-CU-CP;

P0 shall be set to IAB-donor-CU-UP IP address for deriving KIAB-CU-UP.

The entire output of the KDF (256 bits) is used as the KIAB or KIAB-CU-CP or KIAB-CU-UP.

The input key KEY shall be KIAB.

The P1 should be the new IAB-node DU IP address.

The L1 should be the length of the new IAB-node DU IP address.

12. The source IAB-donor-CU sends an IAB TRANSPORT MIGRATION MANAGEMENT REQUEST message to the target IAB-donor-CU, to modify the context of the descendant IAB-node's offloaded traffic. The message may include the DL TNL address information received in step 11 that is necessary for the target IAB-donor-CU to configure or modify DL mappings on the target IAB-donor-DU.

13. The target IAB-donor-CU responds with an IAB TRANSPORT MIGRATION MANAGEMENT RESPONSE message to the source IAB-donor-CU.

14. The steps above may be repeated, if needed, for the source IAB-donor-CU to request addition, modification or release of the offloaded traffic pertaining to the descendant IAB-node. The target IAB-donor-CU can fully or partially reject addition or modification requests by the source IAB-donor-CU.

### IV. Embodiment 3: Radio Link Failure (RLF) Recovery Procedure

The inter-CU backhaul RLF recovery procedure for IAB-nodes in standalone (SA) mode enables recovery of an IAB-node to another parent node underneath a different IAB-donor-CU, when the IAB-MT of the IAB-node detects backhaul RLF.

FIG. 3 shows an example of the backhaul RLF recovery procedure for an IAB-node in SA mode. In this example, the IAB-node changes from its initial parent node to a new parent node, where the new parent node is served by a different IAB-donor-CU than that serving its initial parent node. In this procedure, the recovering IAB-node becomes a boundary IAB-node since the IAB-DU retains F1AP with the initial IAB-donor-CU while its IAB-MT obtains RRC connectivity with the new IAB-donor-CU. A RLF recovery procedure may take 18 steps. Step 14 is modified to send indications to update pre-shared secret keys (PSKs) and generating updated PSKs.

1. The IAB-MT of the IAB-node detects backhaul RLF.

2. The IAB-MT attempts RLF recovery by performing Random Access towards a new parent IAB-DU.

3. The IAB-MT undergoing RLF recovery sends an RRCReestablishmentRequest message to the new parent IAB-DU.

4. The new parent IAB-DU sends an INITIAL UL RRC MESSAGE to the new IAB-donor-CU, to convey the received RRCReestablishmentRequest message.

5. The new IAB-donor-CU retrieves the UE Context for the IAB-MT undergoing recovery, through the XnAP Retrieve UE Context procedure. The initial IAB-donor-CU may include the TNL address information of the IAB-node undergoing recovery in the RRC container of the RETRIEVE UE CONTEXT RESPONSE message.

6. The new IAB-donor-CU sends a DL RRC MESSAGE TRANSFER message to the new parent IAB-DU, to convey the generated RRCReestablishment message.

7. The new parent IAB-DU sends an RRCReestablishment message to the IAB-MT undergoing recovery.

8. The IAB-MT undergoing recovery sends an RRCReestablishmentComplete message to the new parent IAB-DU.

9. The new parent IAB-DU sends an UL RRC MESSAGE TRANSFER message to the new IAB-donor-CU, to convey the received RRCReestablishmentComplete message.

10. The new IAB-donor-CU triggers the UE Context Setup procedure toward the new parent IAB-DU, to create the UE context for the IAB-MT undergoing recovery and to set up one or more bearers. These bearers can be used by the IAB-MT undergoing recovery for its own signaling, and, optionally, data traffic.

11. The new IAB-donor-CU triggers the path switch procedure for the IAB-MT undergoing recovery, if needed.

12. The new IAB-donor-CU sends UE CONTEXT RELEASE message to the initial IAB-donor-CU.

The XnAP UE IDs of the boundary IAB-MT are retained at initial IAB-donor-CU and new IAB-donor-CU as long as the recovery path is used for transport of traffic between the IAB-node undergoing recovery and the initial IAB-donor-CU.

13. The initial IAB-donor-CU may release the BH RLC channels and BAP-sublayer routing entries on the initial path between the initial parent IAB-node and the initial IAB-donor-DU.

14. The new IAB-donor-CU sends a DL RRC MESSAGE TRANSFER message to the new parent IAB-DU, which includes an RRCReconfiguration message for the IAB-MT undergoing recovery. The RRC configuration may include new TNL addresses anchored at the new IAB-donor-DU. The RRC configuration may further include a BAP address for the recovery IAB-node in the new IAB-donor-CU's topology, default BH RLC channel and a default BAP routing ID configuration for UL F1-C/non-F1 traffic mapping on the recovery path. The new IAB-node may also send an indication in a message, such as the RRCReconfiguration message, to indicate that the PSK between the descendant IAB-node and F1-terminating IAB-donor-CU should be changed. The source IAB-node hold the mapping between the old TNL address (IP address), old KIAB, and new TNL address (IP address).

15. The new parent IAB-DU forwards the received RRCReconfiguration message to the IAB-MT undergoing recovery.

16. The IAB-MT undergoing recovery responds to the new parent IAB-DU with an RRCReconfigurationComplete message.

17. The new parent IAB-DU sends an UL RRC MESSAGE TRANSFER message to the new IAB-donor-CU, to convey the received RRCReconfigurationComplete message.

18. The remaining part of the procedure follows the steps 14-20 of the inter-CU topology adaptation procedure defined in clause 8.17.3.1.

Traffic offload for descendant nodes follows the same procedure as that of clause 8.17.3.2.

The new IAB-donor-CU may request the modification of the L2 transport of the offloaded traffic in the new IAB-donor-CU's topology. The new IAB-donor-CU may further reconfigure the TNL addresses of the boundary IAB-node via RRC.

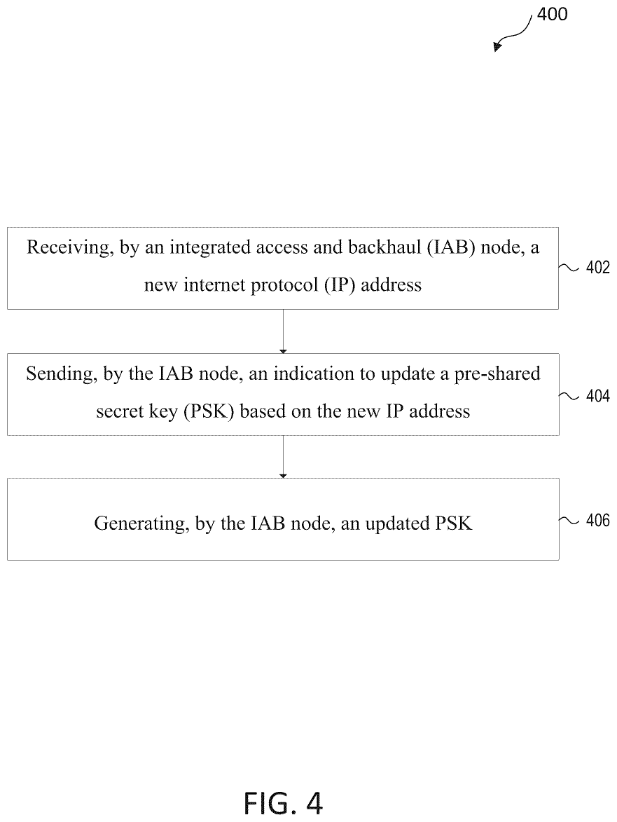

FIG. 4 is an exemplary flowchart for sending an indication to update a pre-shared secret key (PSK). Operation 402 includes receiving, by an integrated access and backhaul (IAB) node, a new internet protocol (IP) address. Operation 404 includes sending, by the IAB node, an indication to update a pre-shared secret key (PSK) based on the new IP address. Operation 406 includes generating, by the IAB node, an updated PSK. In some embodiments, the method can be implemented according to Embodiments 1-3. In some embodiments, performing further steps of the method can be based on a better system performance than a legacy protocol.

In some embodiments, sending the indication includes sending the indication to an IAB donor. In some embodiments, the updated PSK is used between the IAB node and a F1-terminating IAB donor central unit (IAB-donor-CU). In some embodiments, the updated PSK is used to establish a secure F1 interface. In some embodiments, the indication is carried in a message. In some embodiments, the message is one of the following: a handover request acknowledge message, a radio resource control (RRC) reconfiguration message, a gNodeB (gNB) distributed unit (gNB-DU) configuration update message, or an IAB transport migration management response message. In some embodiments, the indication includes an IAB key identifier, and the IAB key identifier includes an old IP address or the new IP address. In some embodiments, the IAB node and a source IAB donor store a mapping between an IAB key and an IAB key identifier, and the key identifier includes an old IP address or the new IP address.

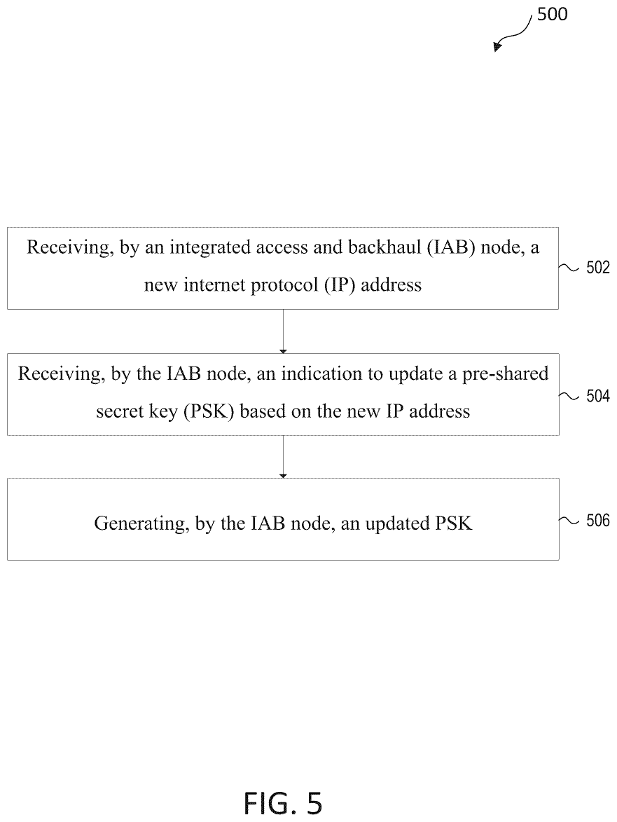

FIG. 5 is an exemplary flowchart for receiving an indication to update a pre-shared secret key (PSK). Operation 502 includes receiving, by an integrated access and backhaul (IAB) node, a new internet protocol (IP) address. Operation 504 includes receiving, by the IAB node, an indication to update a pre-shared secret key (PSK) based on the new IP address. Operation 506 includes generating, by the IAB node, an updated PSK. In some embodiments, the method can be implemented according to Embodiments 1-3. In some embodiments, performing further steps of the method can be based on a better system performance than a legacy protocol.

In some embodiments, receiving the indication includes receiving the indication from a source IAB donor or a target IAB donor. In some embodiments, the updated PSK is used between the IAB node and a F1-terminating IAB donor central unit (IAB-donor-CU). In some embodiments, the updated PSK is used to establish a secure F1 interface. In some embodiments, the indication is carried in a message. In some embodiments, the message is one of the following: a handover request acknowledge message, a radio resource control (RRC) reconfiguration message, a gNodeB (gNB) distributed unit (gNB-DU) configuration update message, or an IAB transport migration management response message. In some embodiments, the indication includes an IAB key identifier, and the IAB key identifier includes an old IP address or the new IP address. In some embodiments, the IAB node and a source IAB donor store a mapping between an IAB key and an IAB key identifier, and the key identifier includes an old IP address or the new IP address.

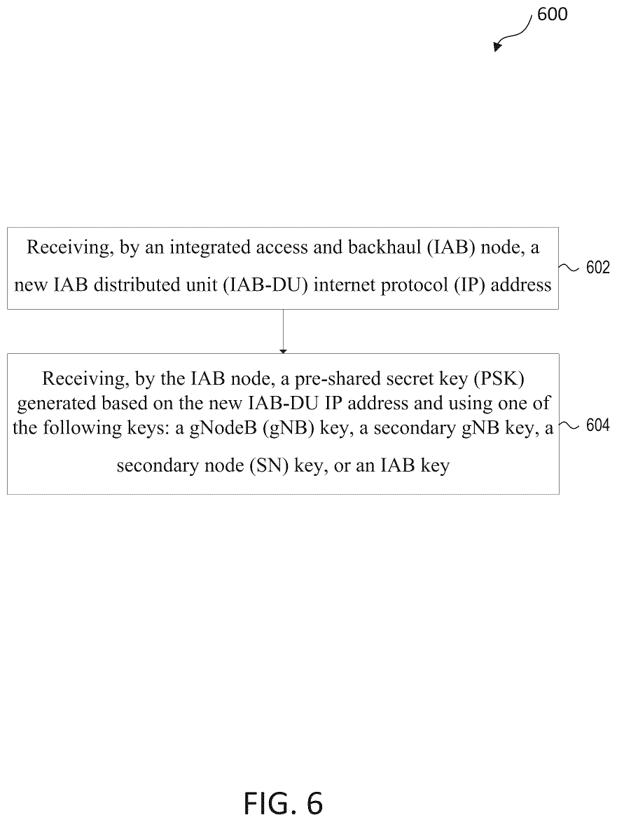

FIG. 6 is an exemplary flowchart for receiving a pre-shared secret key (PSK). Operation 602 includes receiving, by an integrated access and backhaul (IAB) node, a new IAB distributed unit (IAB-DU) internet protocol (IP) address. Operation 604 includes receiving, by the IAB node, a pre-shared secret key (PSK) generated based on the new IAB-DU IP address and using one of the following keys: a gNodeB (gNB) key, a secondary gNB key, a secondary node (SN) key, or an IAB key. In some embodiments, the method can be implemented according to Embodiments 1-3. In some embodiments, performing further steps of the method can be based on a better system performance than a legacy protocol.

In some embodiments, the PSK is generated by a key distribution function (KDF) using the following parameters as an input: an IAB donor central unit (IAB-donor-CU) IP address, a length of the IAB-donor-CU IP address, the new IAB-DU IP address, and a length of the new IAB-DU IP address. In some embodiments, the PSK includes a central unit control plane IAB key (KIAB-CU-CP), and the PSK is generated by a key distribution function (KDF) using an IAB donor central unit control plane (IAB-donor-CU-CP) IP address. In some embodiments, the PSK includes a central unit user plane IAB key (KIAB-CU-UP), and the PSK is generated by a key distribution function (KDF) using an IAB donor central unit user plane (IAB-donor-CU-UP) IP address. In some embodiments, the gNB key is in possession of an IAB user equipment (IAB-UE) functionality in the IAB-node and in an IAB donor central unit (IAB-donor-CU) after an IAB-UE setup procedure. In some embodiments, the gNB key is in possession of an IAB user equipment (IAB-UE) functionality in the IAB-node and in an IAB donor central unit (IAB-donor-CU), where the IAB-donor-CU acts as a master node (MN) for a new radio (NR) dual connectivity (NR-DC) scenario. In some embodiments, the secondary gNB key is in possession of an IAB user equipment (IAB-UE) functionality in the IAB-node and in an IAB donor central unit (IAB-donor-CU) after a dual connectivity procedure. In some embodiments, the secondary gNB key is in possession of an IAB user equipment (IAB-UE) functionality in the IAB-node and in an IAB donor central unit (IAB-donor-CU), where the IAB-donor-CU acts as a SN for an E-UTRA new radio (NR) dual connectivity (EN-DC) scenario. In some embodiments, the SN key is in possession of an IAB user equipment (IAB-UE) functionality in the IAB-node and in an IAB donor central unit (IAB-donor-CU) after a dual connectivity procedure. In some embodiments, the SN key is in possession of an IAB user equipment (IAB-UE) functionality in the IAB-node and in an IAB donor central unit (IAB-donor-CU), where the IAB-donor-CU acts as a SN for a new radio (NR) dual connectivity (NR-DC) scenario. In some embodiments, the method further includes determining an old PSK based on an old IAB-DU IP address or the new IAB-DU IP address.

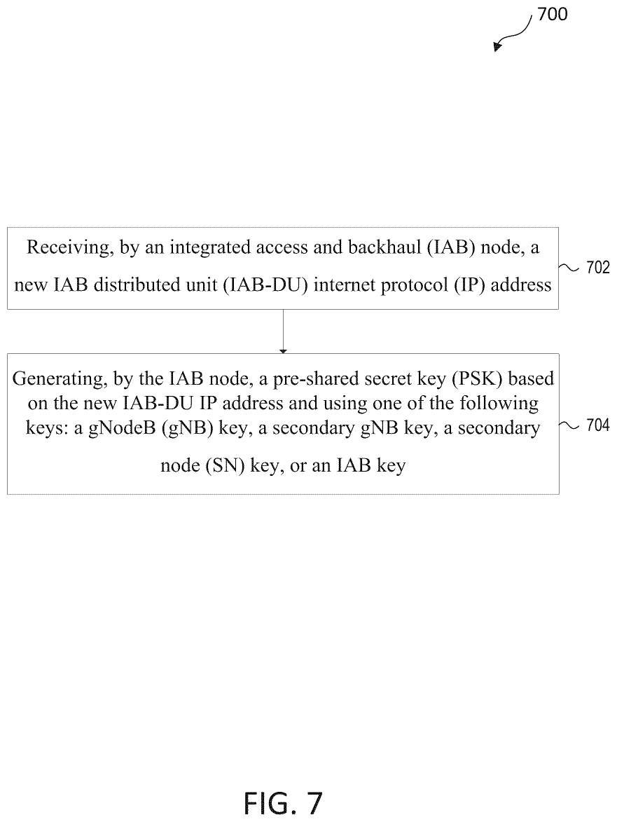

FIG. 7 is an exemplary flowchart for generating a pre-shared secret key (PSK). Operation 702 includes receiving, by an integrated access and backhaul (IAB) node, a new IAB distributed unit (IAB-DU) internet protocol (IP) address. Operation 704 includes generating, by the IAB node, a pre-shared secret key (PSK) based on the new IAB-DU IP address and using one of the following keys: a gNodeB (gNB) key, a secondary gNB key, a secondary node (SN) key, or an IAB key. In some embodiments, the method can be implemented according to Embodiments 1-3. In some embodiments, performing further steps of the method can be based on a better system performance than a legacy protocol.

In some embodiments, the PSK is generated by a key distribution function (KDF) using the following parameters as an input: an IAB donor central unit (IAB-donor-CU) IP address, a length of the IAB-donor-CU IP address, the new IAB-DU IP address, and a length of the new IAB-DU IP address. In some embodiments, the PSK includes a central unit control plane IAB key (KIAB-CU-CP), and the PSK is generated by a key distribution function (KDF) using an IAB donor central unit control plane (IAB-donor-CU-CP) IP address. In some embodiments, the PSK includes a central unit user plane IAB key (KIAB-CU-UP), and the PSK is generated by a key distribution function (KDF) using an IAB donor central unit user plane (IAB-donor-CU-UP) IP address. In some embodiments, the gNB key is in possession of an IAB user equipment (IAB-UE) functionality in the IAB-node and in an IAB donor central unit (IAB-donor-CU) after an IAB-UE setup procedure. In some embodiments, the gNB key is in possession of an IAB user equipment (IAB-UE) functionality in the IAB-node and in an IAB donor central unit (IAB-donor-CU), where the IAB-donor-CU acts as a master node (MN) for a new radio (NR) dual connectivity (NR-DC) scenario. In some embodiments, the secondary gNB key is in possession of an IAB user equipment (IAB-UE) functionality in the IAB-node and in an IAB donor central unit (IAB-donor-CU) after a dual connectivity procedure. In some embodiments, the secondary gNB key is in possession of an IAB user equipment (IAB-UE) functionality in the IAB-node and in an IAB donor central unit (IAB-donor-CU), where the IAB-donor-CU acts as a SN for an E-UTRA new radio (NR) dual connectivity (EN-DC) scenario. In some embodiments, the SN key is in possession of an IAB user equipment (IAB-UE) functionality in the IAB-node and in an IAB donor central unit (IAB-donor-CU) after a dual connectivity procedure. In some embodiments, the SN key is in possession of an IAB user equipment (IAB-UE) functionality in the IAB-node and in an IAB donor central unit (IAB-donor-CU), where the IAB-donor-CU acts as a SN for a new radio (NR) dual connectivity (NR-DC) scenario. In some embodiments, the method further includes determining an old PSK based on an old IAB-DU IP address or the new IAB-DU IP address.

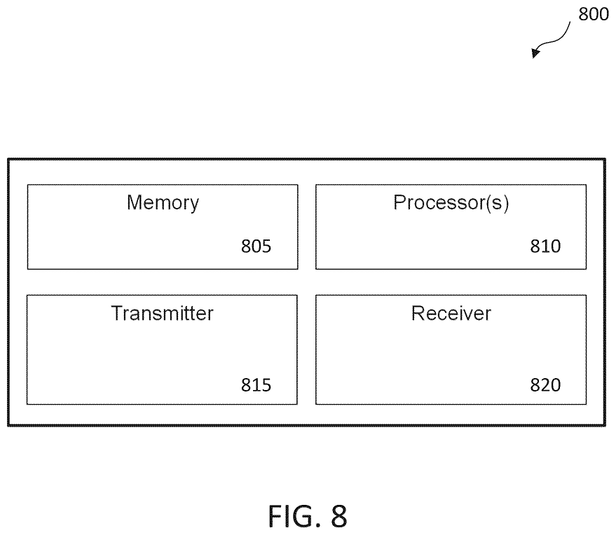

FIG. 8 shows an exemplary block diagram of a hardware platform 800 that may be a part of a network device (e.g., base station or an IAB node) or a communication device (e.g., a user equipment (UE)). The hardware platform 800 includes at least one processor 810 and a memory 805 having instructions stored thereupon. The instructions upon execution by the processor 810 configure the hardware platform 800 to perform the operations described in FIGS. 1 to 7 and in the various embodiments described in this patent document. The transmitter 815 transmits or sends information or data to another device. For example, a network device transmitter can send a message to a user equipment. The receiver 820 receives information or data transmitted or sent by another device. For example, a user equipment can receive a message from a network device. For example, a UE or a network device, as described in the present document, may be implemented using the hardware platform 800.

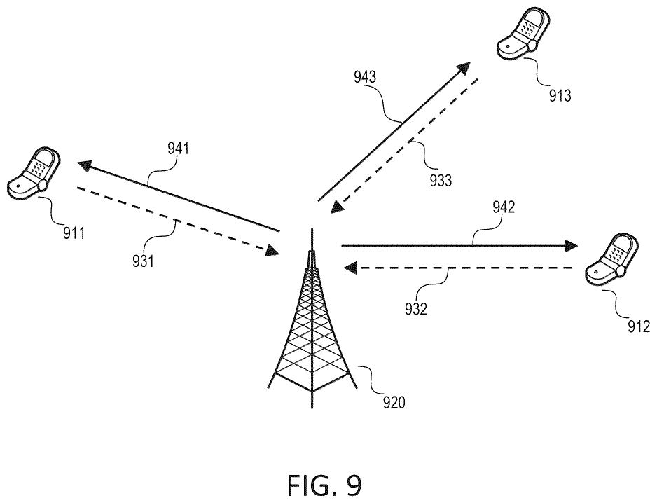

The implementations as discussed above will apply to a wireless communication. FIG. 9 shows an example of a wireless communication system (e.g., a 5G or NR cellular network) that includes a base station 920 and one or more user equipment (UE) 911, 912 and 913. In some embodiments, the UEs access the BS (e.g., the network) using a communication link to the network (sometimes called uplink direction, as depicted by dashed arrows 931, 932, 933), which then enables subsequent communication (e.g., shown in the direction from the network to the UEs, sometimes called downlink direction, shown by arrows 941, 942, 943) from the BS to the UEs. In some embodiments, the BS send information to the UEs (sometimes called downlink direction, as depicted by arrows 941, 942, 943), which then enables subsequent communication (e.g., shown in the direction from the UEs to the BS, sometimes called uplink direction, shown by dashed arrows 931, 932, 933) from the UEs to the BS. The UE may be, for example, a smartphone, a tablet, a mobile computer, a machine to machine (M2M) device, an Internet of Things (IoT) device, and so on. The UEs described in the present document may be communicatively coupled to the base station 920 depicted in FIG. 9. The UEs can also communicate with BS for CSI communications.

It will be appreciated by one of skill in the art that the present document discloses methods to send indications to update pre-shared secret keys (PSKs) and generate updated PSKs. The indications can be sent by the IAB node, the source IAB donor, or the target IAB donor. The PSKs can be generated by the IAB node, the source IAB donor, or the target IAB donor using a gNodeB (gNB) key, a secondary gNB key, a secondary node (SN) key, or an IAB key.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
receiving, by an integrated access and backhaul (IAB) node, a new internet protocol (IP) address;
sending, by the IAB node, an indication to update a pre-shared secret key (PSK) based on the new IP address; and
generating, by the IAB node, an updated PSK;
or,
receiving, by an integrated access and backhaul (IAB) node, a new internet protocol (IP) address; receiving, by the IAB node, an indication to update a pre-shared secret key (PSK) based on the new IP address; and generating, by the IAB node, an updated PSK.

2. (canceled)

3. The method of claim 1, wherein sending the indication comprises sending the indication to an IAB donor.

4. The method of claim 2, wherein receiving the indication comprises receiving the indication from a source IAB donor or a target IAB donor.

5. The method of claim 1, wherein the updated PSK is used between the IAB node and a F1-terminating IAB donor central unit (IAB-donor-CU).

6. The method of claim 1, wherein the updated PSK is used to establish a secure F1 interface.

7. The method of claim 1, wherein the indication is carried in a message.

8. The method of claim 7, wherein the message is one of the following: a handover request acknowledge message, a radio resource control (RRC) reconfiguration message, a gNodeB (gNB) distributed unit (gNB-DU) configuration update message, or an IAB transport migration management response message.

9. The method of claim 1, wherein the indication comprises an IAB key identifier, and wherein the IAB key identifier comprises an old IP address or the new IP address.

10. The method of claim 1, wherein the IAB node and a source IAB donor store a mapping between an IAB key and an IAB key identifier, and wherein the key identifier comprises an old IP address or the new IP address.

11. A method of wireless communication, comprising:
receiving, by an integrated access and backhaul (IAB) node, a new IAB distributed unit (IAB-DU) internet protocol (IP) address; and
receiving, by the IAB node, a pre-shared secret key (PSK) generated based on the new IAB-DU IP address and using one of the following keys: a gNodeB (gNB) key, a secondary gNB key, a secondary node (SN) key, or an IAB key;
or,
receiving, by an integrated access and backhaul (IAB) node, a new IAB distributed unit (IAB-DU) internet protocol (IP) address; and generating, by the IAB node, a pre-shared secret key (PSK) based on the new IAB-DU IP address and using one of the following keys: a gNodeB (gNB) key, a secondary gNB key, a secondary node (SN) key, or an IAB key.

12. (canceled)

13. The method of claim 11, wherein the PSK is generated by a key distribution function (KDF) using the following parameters as an input: an IAB donor central unit (IAB-donor-CU) IP address, a length of the IAB-donor-CU IP address, the new IAB-DU IP address, and a length of the new IAB-DU IP address.

14. The method of claim 11, wherein
the PSK comprises a central unit control plane IAB key (KIAB-CU-CP), and wherein the PSK is generated by a key distribution function (KDF) using an IAB donor central unit control plane (IAB-donor-CU-CP) IP address;
or,
the PSK comprises a central unit user plane IAB key (KIAB-CU-UP), and wherein the PSK is generated by a key distribution function (KDF) using an IAB donor central unit user plane (IAB-donor-CU-UP) IP address.

15. (canceled)

16. The method of claim 11, wherein
the gNB key is in possession of an IAB user equipment (IAB-UE) functionality in the IAB-node and in an IAB donor central unit (IAB-donor-CU) after an IAB-UE setup procedure;
or,
the gNB key is in possession of an IAB user equipment (IAB-UE) functionality in the IAB-node and in an IAB donor central unit (IAB-donor-CU), and wherein the LAB-donor-CU acts as a master node (MN) for a new radio (NR) dual connectivity (NR-DC) scenario.

17. (canceled)

18. The method of claim 11, wherein
the secondary gNB key is in possession of an IAB user equipment (IAB-UE) functionality in the IAB-node and in an IAB donor central unit (IAB-donor-CU) after a dual connectivity procedure;
or,
the secondary gNB key is in possession of an IAB user equipment (IAB-UE) functionality in the IAB-node and in an IAB donor central unit (LAB-donor-CU), and wherein the IAB-donor-CU acts as a SN for an E-UTRA new radio (NR) dual connectivity (EN-DC) scenario.

19. (canceled)

20. The method of claim 11, wherein
the SN key is in possession of an IAB user equipment (IAB-UE) functionality in the IAB-node and in an IAB donor central unit (LAB-donor-CU) after a dual connectivity procedure;
or,
the SN key is in possession of an IAB user equipment (IAB-UE) functionality in the IAB-node and in an IAB donor central unit (IAB-donor-CU), and wherein the IAB-donor-CU acts as a SN for a new radio (NR) dual connectivity (NR-DC) scenario.

21. (canceled)

22. The method of claim 11, further comprising determining an old PSK based on an old IAB-DU IP address or the new IAB-DU IP address.

23. An apparatus for wireless communication, comprising a processor, wherein the processor is configured to implement a method recited in claim 1.

24. A non-transitory computer readable program storage medium having code stored thereon, the code, when executed by a processor, causing the processor to implement a method recited in claim 1.

25. An apparatus for wireless communication, comprising a processor, wherein the processor is configured to implement a method recited in claim 11.

26. A non-transitory computer readable program storage medium having code stored thereon, the code, when executed by a processor, causing the processor to implement a method recited in claim 11.
